(19) United States
(12) Patent Application Publication
(10) Pub. No.: US 2006/0253878 A1
(43) Pub. Date: Nov. 9, 2006

(54) Vehicular entertainment module

(76) Inventors: J. Roger Davis, Russiaville, IN (US); J. Robert Dockemeyer JR., Kokomo, IN (US); William E. Dyson, Carmel, IN (US); Jerral A. Long, Kokomo, IN (US); Douglas G. Borders, Kokomo, IN (US)

Correspondence Address: DELPHI TECHNOLOGIES, INC., M/C 480-410-202, PO BOX 5052, TROY, MI, 48007, US

(21) Appl. No.: 11/125,060

(22) Filed: May 9, 2005

(51) Int. Cl. H04N 7/18

(52) U.S. Cl. 725/75; 725/77

(57) ABSTRACT

A vehicular entertainment module is disclosed. The vehicular entertainment module includes a video screen, speakers/headphones, an audio/video input device, and a satellite antenna and receiver. The audio/video input device processes media input by a user. The satellite antenna and receiver receives satellite audio signals and satellite video signals for decoding by an audio and video data decoder. The video screen and speakers/headphones provide video and audio output from the the audio/video input device or the received satellite audio signals and satellite video signals.

### FIELD OF THE INVENTION

The invention relates to vehicular audio and video devices. More particularly, the invention relates to an entertainment module with an audio/video input device(s) integrated with a satellite audio and video device.

### BACKGROUND OF THE INVENTION

It is known in the art that vehicles currently employ various entertainment systems for the enjoyment of the vehicle operator and passengers. For example, some vehicles may employ satellite digital audio radio services, which has been commonly referred to in the art as “SDARS.” SDARS typically offers a digital broadcast of audio from satellites in either a geo-stationary orbit or a highly elliptical orbit that receive up-linked programming, which, in turn, is re-broadcasted directly to vehicle receivers that subscribe to the service. In another example, vehicles are also being manufactured with rear seat entertainment systems that employ a screen for viewing broadcast television or movies from a digital video disc (DVD).

A vehicle employing such dissimilar audio and video systems require individual control circuitry, software, power supplies, memory, vehicle interface connectors, casings, and dedicated vehicle harnessing for each system. Accordingly, complexity in the wiring, costs of material, and costs of installation are incurred when dissimilar systems are employed in the vehicle. Accordingly, a need therefore exists to reduce system cost and complexity of dissimilar audio and video systems employed in a vehicle.

### BRIEF DESCRIPTION OF THE DRAWINGS

The inventors of the present invention have recognized these and other problems associated with dissimilar audio and video systems employed in a vehicle. The present invention will now be described, by way of example, with reference to the accompanying drawings, in which:

FIG. 1 is a graphical representation of a vehicular entertainment module according to an embodiment;

FIG. 2 is a graphical representation of a vehicular entertainment module according to another embodiment; and

FIG. 3 is a graphical representation of a vehicular entertainment module according to another embodiment.

### DESCRIPTION OF THE PREFERRED EMBODIMENT

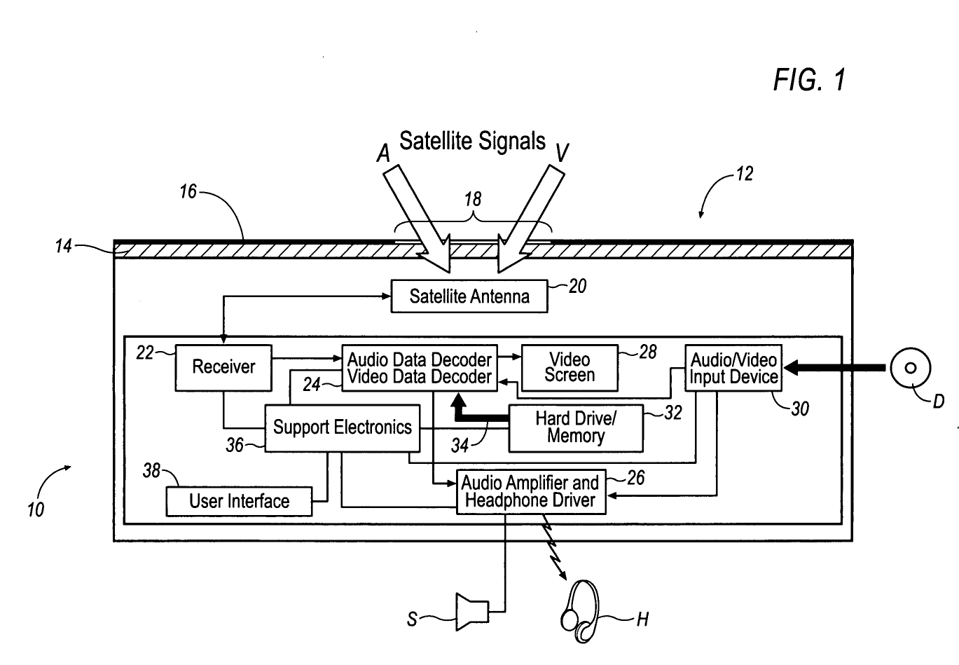

The above-described disadvantages are overcome and a number of advantages are realized by an inventive vehicular entertainment module, which is shown generally at 10, 100, 200 in FIGS. 1-3, respectively. In general, the vehicular entertainment module 10, 100, 200 employs audio and video entertainment features in one, stand-alone unit. According to a first aspect of the invention, the vehicular entertainment module 10, 100, 200 provides audio and video entertainment emanating from external media, such as a cassette, video game programming, a DVD, or compact disc (CD) that is manually placed into the vehicular entertainment module 10, 100, 200. According to another aspect of the invention, the vehicular entertainment module 10, 100, 200 provides audio and video entertainment emanating from a satellite broadcast that is received by a satellite antenna. Accordingly, cost and design complexity is reduced by sharing components and subsystems in an integrated unit that are otherwise utilized on an individual basis as employed in the prior art.

Referring initially to FIG. 1, the vehicular entertainment module 10 is located adjacent a vehicular roof 12 including a headliner 14, an outer metallic portion 16, and an outer non-metallic portion 18. As illustrated, a satellite antenna 20 is integrally located within the vehicular entertainment module 10 and is positioned proximate the outer non-metallic portion 18 of the vehicle roof 12 to permit reception of satellite audio signals, A, and satellite video signals, V. The headliner 14 also comprises a non-metallic material, and, accordingly, the satellite audio signals, A, and satellite video signals, V, are permitted to pass there-through as well. Upon receiving the satellite audio and video signals, A, V, at the satellite antenna 20, a receiver 22 passes the satellite audio and video signals, A, V, to an audio and video data decoder 24 for decoding the satellite audio and video signals, A, V, prior to being output at an audio amplifier & headphone driver 26 and a video screen 28, respectively. As illustrated, the audio amplifier & headphone driver 26 provides an audible output to speakers, S, and/or hardwired or wireless headphones, H.

As illustrated, the vehicular entertainment module 10 also includes an audio/video input device 30, such as a DVD player or video game console, for providing audio output by way of audio reproducing devices (e.g. speakers/headphones, S, H), and video output to the video screen 28 upon inserting the media, such as a DVD or video game programming, which is shown generally at D, into the vehicular entertainment module 10. The vehicular entertainment module 10 may also include a hard drive/memory 32 that provides saved audio and video information, which is shown generally at 34, to the audio and video data decoder 24. The saved audio and video information 34 may be, for example, downloaded audio or video from the satellite audio and video, A, V, or, alternatively, the saved audio and video information 34 may be, for example, pre-programmed onto the hard drive/memory 32. The audio and video data decoder 24 may include a single processor that decodes audio and video originating from the audio/video input device 30, the satellite audio signals, A, and the satellite video signals, V.

The vehicular entertainment module 10 also includes shared support electronics 36 for operating the receiver 22, the audio and video data decoder 24, the audio/video input device 30, and the hard drive/memory 32. The support electronics 36 may include a microcontroller, software blocks, memory, a vehicle communication interface, power supplies, a vehicle connector interface, a cooling device, and the like. A user interface 38 may also communicate with the support electronics 36 for operating the vehicular entertainment module 10. The user interface 38 may include, for example, buttons, lights, and a display screen; if desired, the video screen 28 may be employed as the display screen for the user interface 38.

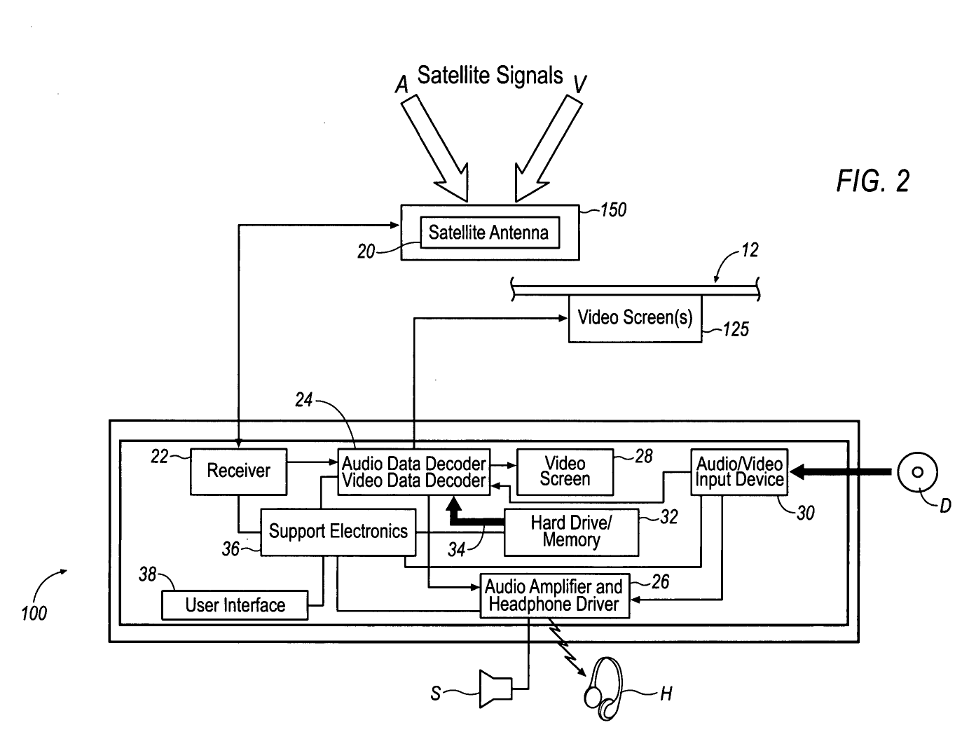

Referring to FIG. 2, the vehicular entertainment module 100 operates on the same principles and includes the same components described in FIG. 1. As illustrated in FIG. 2, the satellite antenna 20 is shown in a remote location 150 from the vehicular entertainment module 100. The satellite antenna 20 may be positioned at any desirable remote location 150 about the vehicle, such as, for example, under a trunk lid, behind an instrument panel, within a side-view mirror housing, an exterior mounting on the vehicle roof, or the like. Even further the location of the vehicular entertainment module 100 may not necessarily be adjacent a vehicle roof 12 as described in FIG. 1. For example, the vehicular entertainment module 100 may be located within or proximate to a rear seat center console such that the video screen 28 is located closer to the floor-pan of the vehicle. Accordingly, remotely-located video screens 125 may be located anywhere within the vehicle, such as, for example, adjacent the vehicle roof 12 so that occupants in a third or fourth row seating position may view the video contents being processed by the vehicular entertainment module 100.

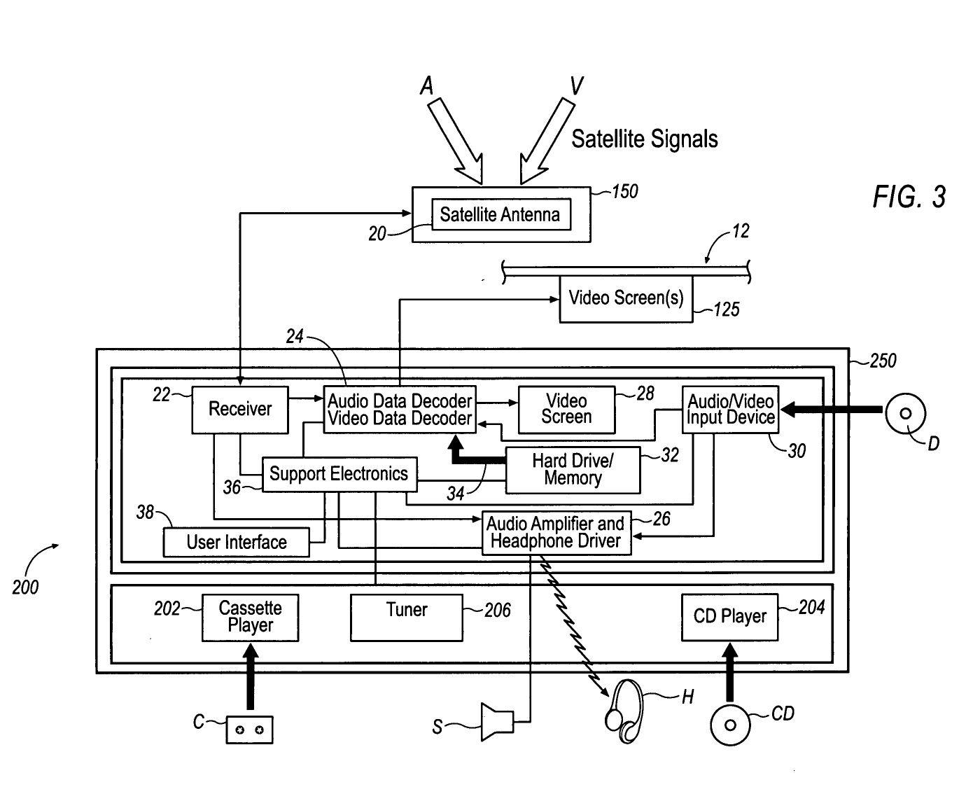

Referring to FIG. 3, the vehicular entertainment module 200 operates on the same principles and includes the same components described in FIGS. 1 and 2. As illustrated in FIG. 3, the vehicular entertainment module 200 is located within a head unit 250 proximate a dashboard area. As illustrated, the head unit 250 includes other input audio devices, such as, for example, a cassette player 202 and a CD player 204 that accepts a cassettes, C, and/or a compact disc, CD, input by a user. In addition to the cassette and CD player 202, 204, the head unit 250 also includes a tuner 206 for tuning audio being broadcast on any desirable band, such as, for example, AM/FM (i.e., the 540-1700 kHz and 88.1-107.9 MHz bands) and DAB (i.e., digital audio broadcast on the 174-240 MHz and 1452-1492 MHz bands). Even further, the head unit may also providing tuning of HD RADIO™, which is commercially available from iBiquity Digital Corporation of Delaware, Md. HD RADIO™ uses in-band on-channel (IBOC) information to improve the sound quality of both AM and FM broadcasts while adding features available with digital technology, such as displaying text or rich media on the radio face plate. Accordingly, HD RADIO™ is broadcast as “sideband” transmissions bracketing the top and bottom of a host analog signal in order to make optimal usage of the current spectrum allocations.

The satellite audio and video signals, A, V, received by the vehicular entertainment module 10, 100, 200 may be broadcast in any desirable band, such as, for example, the 2320-2345 MHz frequency band, which is the SDARS band. Accordingly, the satellite audio signals, A, may include any desirable programming, such as music, talk radio, and the like. User interface information associated with the satellite audio signals, A, such as station numbers, artist name, and the like is typically transmitted with the satellite audio signal, A, for representation on a user interface screen. The satellite video signals, V, may include any desirable video information, such as television programming, movies, video games, navigation information (e.g., maps), graphical representations (e.g., stock information), and the like. The satellite video signals, V, may be received by the receiver 22 and decoded by the audio and video data decoder 24 for output over the video screen 28, or, alternatively, the satellite video signals, V, may be downloaded into the hard drive/memory 32 for decoding and output at a desired time.

While the invention has been specifically described in connection with certain specific embodiments thereof, it is to be understood that this is by way of illustration and not of limitation, and the scope of the appended claims should be construed as broadly as the prior art will permit.

What is claimed is:

1. A vehicular entertainment module, comprising:
a video screen and audio reproducing devices;
an audio/video input device that processes media input by a user; and
a satellite antenna and receiver that receives satellite signals carrying both audio and video information for decoding by an audio and video data decoder, wherein the video screen and the audio reproducing devices provide video and audio output from the the audio/video input device or the received satellite signals.

2. The vehicular entertainment module according to claim 1, wherein the satellite antenna is located within the vehicular entertainment module adjacent a vehicle roof.

3. The vehicular entertainment module according to claim 2, wherein the vehicle roof includes a headliner, an outer metallic portion, and an outer non-metallic portion, wherein the satellite antenna is positioned proximate the outer non-metallic portion.

4. The vehicular entertainment module according to claim 1, wherein the satellite antenna is positioned in a remote location from the vehicular entertainment module.

5. The vehicular entertainment module according to claim 4, wherein the remote location is under a trunk lid, an exterior surface of a vehicle, behind an instrument panel, or within a side-view mirror housing.

6. The vehicular entertainment module according to claim 4 further comprising a second video screen that is remotely located from the vehicular entertainment module, wherein the vehicular entertainment module is located proximate a rear seat center console.

7. The vehicular entertainment module according to claim 1, wherein the vehicular entertainment module is located within a head unit proximate a front dashboard area, wherein the head unit includes one or more audio input devices and a tuner for tuning audio being broadcast on a host analog signal broadcast on the 540-1700 kHz band, the 88.1-107.9 MHz band, the 174-240 MHz band, or the 1452-1492 MHz band.

8. The vehicular entertainment module according to claim 7, wherein the broadcast audio includes sideband transmissions for adding digital media and improving sound quality of the host analog signal.

9. The vehicular entertainment module according to claim 7, wherein the one or more audio input devices include a cassette player and/or a compact disc player.

10. The vehicular entertainment module according to claim 1, wherein the audio/video input device is a digital video disc player, wherein the media is a digital video disc.

11. The vehicular entertainment module according to claim 1, wherein the audio/video input device is a video game console, wherein the media is video game programming.

12. The vehicular entertainment module according to claim 1, wherein the video output is television programming, a movie, a video game, navigation information, or graphical representations.

13. The vehicular entertainment module according to claim 1, wherein the satellite audio and video signals are broadcast in the 2320-2345 MHz frequency band.

14. The vehicular entertainment module according to claim 1, wherein the audio and video data decoder includes a processor that decodes audio and video originating from the audio/video input device, the satellite audio signals and the satellite video signals.

15. A vehicular entertainment module, comprising:
a video screen and speakers/headphones;
an audio/video input device that processes media input by a user; and
a satellite antenna and receiver that receives satellite audio signals and satellite video signals for decoding by an audio and video data decoder, wherein the satellite antenna is located within the vehicular entertainment module and located adjacent a vehicle roof, wherein the video screen and speakers/headphones provide video and audio output from the the audio/video input device or the received satellite audio signals and satellite video signals.

16. A vehicular entertainment module, comprising:
a video screen and speakers/headphones;
an audio/video input device that processes media input by a user; and
a satellite antenna and receiver that receives satellite audio signals and satellite video signals for decoding by an audio and video data decoder, wherein the satellite antenna is positioned in a remote location from the vehicular entertainment module, wherein the video screen and speakers/headphones provide video and audio output from the the audio/video input device or the received satellite audio signals and satellite video signals.

17. A vehicular entertainment module, comprising:
a video screen and speakers/headphones;
an audio/video input device that processes media input by a user; and
a satellite antenna and receiver that receives satellite audio signals and satellite video signals for decoding by an audio and video data decoder, wherein the vehicular entertainment module is located within a head unit proximate a front dashboard area, wherein the head unit includes one or more audio input devices and a tuner for tuning audio being broadcast on an AM/FM band, a DAB band, or an HD band, wherein the video screen and speakers/headphones provide video and audio output from the the audio/video input device or the received satellite audio signals and satellite video signals.
